(19) United States
(12) Patent Application Publication
(10) Pub. No.: US 2018/0134402 A1
(43) Pub. Date: May 17, 2018

(54) BIPARTITE CRADLE WITH SLIDE FOR TURBOMACHINE

(71) Applicants: Antoine Elie Hellegouarch, Crosne (FR); Frédéric Paul Eichstadt, Melun (FR); Thomas Gérard Daniel Riviere, Noisy-le-Grand (FR)

(72) Inventors: Antoine Elie Hellegouarch, Crosne (FR); Frédéric Paul Eichstadt, Melun (FR); Thomas Gérard Daniel Riviere, Noisy-le-Grand (FR)

(73) Assignee: SAFRAN AIRCRAFT ENGINES, Paris (FR)

(21) Appl. No.: 15/812,864

(22) Filed: Nov. 14, 2017

(30) Foreign Application Priority Data
Nov. 14, 2016 (FR) 1660960

(51) Int. Cl. B64D 27/26; B64D 27/12; F02C 7/20

(52) U.S. Cl. CPC B64D 27/26; B64D 2027/264; F02C 7/20; B64D 27/12

(57) ABSTRACT

A cradle for supporting an aircraft turbine engine, said cradle comprising an attachment interface for attaching a gas generator of the turbine engine. The cradle is produced in at least two portions comprising: an upper half-cradle, which is designed to be attached to a wing of the aircraft, a lower half-cradle, which is movable between a position in which it is connected to the upper half-cradle and a position in which it is disconnected from the upper half-cradle, and which comprises at least a portion of the attachment interface for attaching the gas generator, a guide configured for slidably guiding the lower half-cradle between the connected and disconnected positions thereof, and at least one lock for locking the lower half-cradle in the connected position thereof.

### TECHNICAL FIELD OF THE INVENTION:

The present invention relates to the attachment of power units to aircraft. The invention relates to a cradle capable of ensuring that a turbine engine is fastened or suspended under or on a wing of an aircraft, and more particularly to a cradle capable of allowing easy removal or re-installation of the turbine engine in order to simplify turbine-engine maintenance operations.

### PRIOR ART:

In general, a turbine engine is located in an airflow path when the aeroplane is moving. The suspension system of the turbine engine, which allows said turbine engine to be connected to the aeroplane, must occupy as little space as possible around the engine in order to minimise the size of the obstacle formed by the power unit in airflows, be they airflows generated by movement of the aircraft or airflows generated by the fan or propeller of the turbine engine. Indeed, if the turbine engine is a turboprop engine, it is also located in the airflow generated by the propeller thereof.

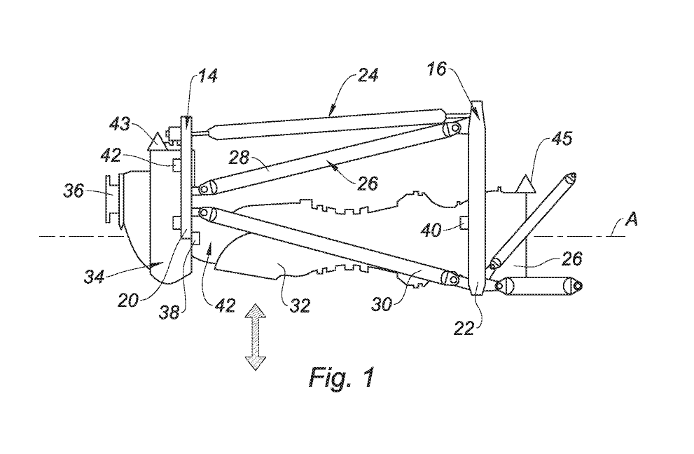

FIG. 1 shows a cradle 10 according to the prior art which forms a suspension system that is more particularly suitable for a substantially horizontal turboprop engine 12, comprising, as is known, a gas generator 32 having a substantially horizontal longitudinal axis A and a reduction gear 34 comprising a hub 36 which is intended to drive a propeller (not shown in FIG. 1).

A cradle 10 of this kind is composed, for example, of two arches 14, 16, one front and one rear, extending transversely with respect to the axis A and open at the lower ends 20, 22 thereof. The arches 14, 16 are interconnected by means of at least one upper axial spar 24 and by means of a trellis 26 of connecting rods which extends between the arches 14, 16. The trellis 26 of connecting rods comprises, for example, in a non-limiting manner, an upper connecting rod 28 and a lower connecting rod 30, which are provided on either side of the arches 14, 16.

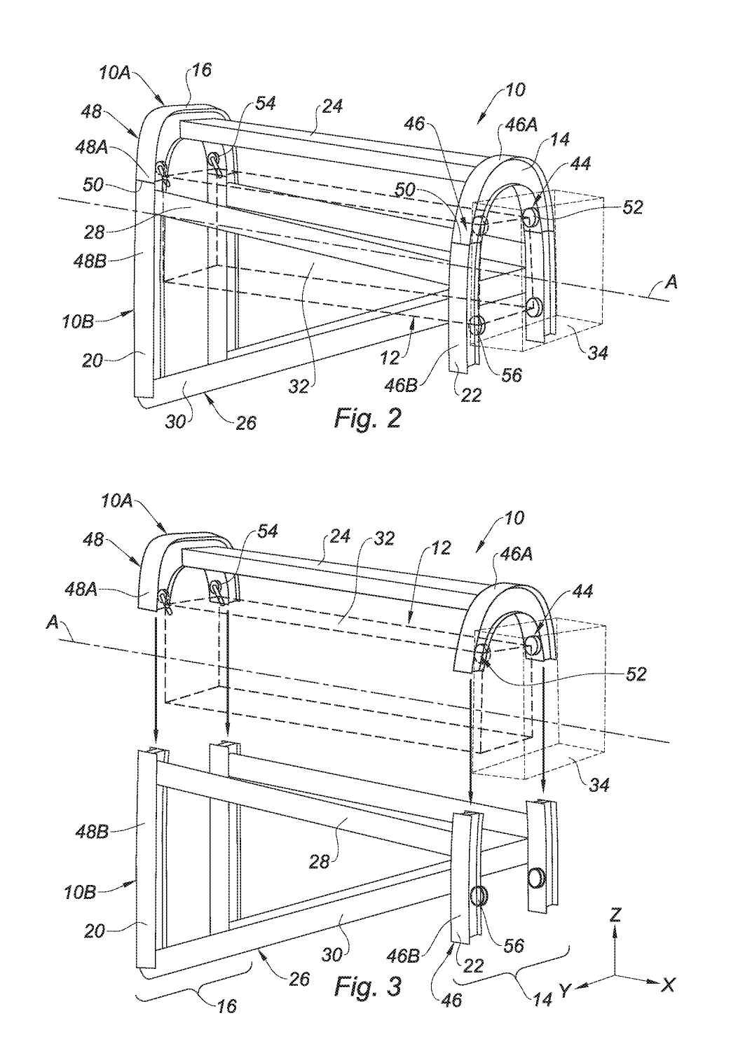

The arches 14, 16, as is known, have the shape of an inverted U (not shown in FIG. 1), in a similar way to the arches which will be described later with reference to FIGS. 2 to 5, which depict the invention. The cradle 10 is arranged as close to the turboprop engine 12 as possible in order to reduce the aerodynamic drag of said cradle 10, and the turboprop engine 12 is attached to the cradle 10 via attachment means.

The cradle 10 is thus intended to surround the turboprop engine 12 as closely as possible while leaving the bottom portion of the turboprop engine 12 exposed, be this to ensure that said turboprop engine is kept in the cradle 10 or to enable the installation or removal operations thereof, in the direction of the double-headed arrow shown in FIG. 1.

Conventionally, the gas generator 32 and the reduction gear 36 form a single assembly which is installed in the cradle 10, or removed from said cradle 10. The turboprop engine 12 comprises means for attachment to the cradle 10, for example attachment pads 38 allowing attachment of the gas generator 32 to the front arch 14, attachment pads 40 allowing attachment of the gas generator 32 to the rear arch 16, and attachment pads 42 allowing attachment of the reduction gear 34 to the front arch 14. In FIG. 1, the pads 38, 40 and 42 are shown schematically.

The turboprop engine 12 moreover comprises lifting eyes 43 and 45 arranged at the front and rear ends thereof, in order to allow the installation or removal thereof.

When it is desired to access a turbine engine such as this turboprop engine 12, it is conventionally necessary to remove same from the cradle 10. Indeed, the above-described arrangement does not allow access to the turbine engine 12 when said turbine engine is received in the cradle 10, as the connecting rods 28, 30 of the trellis 26 of connecting rods impede access to the turbine engine 12, and in particular to the gas generator 32 or to the devices thereof.

Furthermore, when it is desired to remove the turboprop engine 12, the turboprop engine 12 must be held, for example by means of hoists fastened to the eyes 44 and 46, then the pads 38, 40 and 42 must be removed, and then the turboprop engine must be lowered onto a support.

This last operation is particularly tricky, as the turboprop engine 12 has to be lowered between the arches 14, 16 of the cradle without touching them, in order to prevent components of the turboprop engine 12, such as pipes or devices such as a computer, from being damaged.

In the case of the turboprop engine 12 being suspended by hoists, said operation is all the more tricky given that the turboprop engine 12 often has the tendency to rock and is therefore more likely to come into contact with the cradle than when supported by a holding means of another type.

The problem is substantially the same when the turbine engine is, for example, a bypass turbine engine equipped with a fan.

EP 1 449 766 A1 describes a cradle composed of two portions, one upper and one lower. Said cradle does not solve the aforementioned problem since the turboprop engine is only attached in the upper cradle, the lower cradle only having a fairing function.

WO-2008/00924-A1 describes and shows a nacelle of a bypass turbojet engine comprising a front air-inlet section, a middle section intended to surround a fan of the turbojet engine, and a rear section comprising an internal structure used as a structuring casing for supporting a rear portion of the turbojet engine referred to by persons skilled in the art as a “gas generator”. The gas generator comprises at least one compressor, a combustion chamber and at least one turbine driven by the combustion gases. Said rear section is designed to be attached to a strut of the aircraft in which said rear section is provided. The internal structure of said rear section traps the rear portion of the turbojet engine and is composed of two sub-portions that are separable in a vertical plane.

This design does not allow access to the turbojet engine installed in the internal structure of the nacelle, and thus necessitates complete removal of the turbojet engine prior to any intervention.

Within the context of the example described above, a solution is therefore required which allows either to simplify access to the turboprop engine 12 installed in said cradle or to secure the lowering of the turboprop engine 12 from the cradle 10 or the raising thereof into the cradle 10, while avoiding any interference with said cradle 10.

More generally, a solution is required which allows either to simplify access to a turbine engine installed in a cradle or to secure the lowering of the turbine engine from the cradle or the raising thereof into the cradle, while avoiding any interference with said cradle.

The object of the present invention is to propose a solution of this kind.

### DESCRIPTION OF THE INVENTION:

To this end, the invention proposes a cradle produced in two separable portions that are guided relative to one another and both participate in the attachment of the turbine engine.

Accordingly, the invention proposes a cradle for supporting an aircraft turbine engine which is intended to be oriented so as to follow a substantially axial direction and which comprises at least one gas generator, said cradle comprising a front arch and a rear arch, which extend transversely with respect to said axial direction, said arches being open at the lower ends thereof and interconnected by structuring connection means comprising at least one trellis of connecting rods that extend between said arches and said cradle comprising means for attaching the gas generator, said cradle being produced in at least two portions and comprising:
an upper half-cradle, which is designed to be attached to a wing of the aircraft,
a lower half-cradle, said lower half-cradle being movable between a position in which it is connected to the upper half-cradle and a position in which it is disconnected from the upper half-cradle,

characterised in that the lower half-cradle comprises at least some of the means for attaching the gas generator, and in that the cradle comprises:
means for slidably guiding the lower half-cradle in a vertical direction between the connected and disconnected positions thereof, and
means for locking the lower half-cradle relative to the upper half-cradle in the connected position thereof.

According to further features of the invention, which may be combined with one another or provided in isolation from one another:
the cradle is designed to support a turbine engine of the turboprop engine type, comprising a reduction gear coupled to the gas generator, and the upper half-cradle comprises at least some of the means for attaching said reduction gear,
each front and rear arch of the cradle comprises substantially vertical arms, each arm comprising an upper half-arm of the upper half-cradle and a lower half-arm of the lower half-cradle, and the means for slidable guiding are interposed between or supported by the upper half-arms and the lower half-arms corresponding thereto,
each means for slidable guiding comprises a rail that is rigidly connected to an upper/lower half-arm and slidably receives a complementary member that is rigidly connected to the other lower/upper half-arm, respectively,
the means for locking the lower half-cradle relative to the upper half-cradle in the connected position thereof comprise at least two locks interposed between two lower and upper half-arms of the rear arch and two lower and upper half-arms of the front arch,
each lock is movable between an unlocked position and a locked position, and comprises a visual indicator of the locked position thereof,
the cradle comprises at least one actuator which is interposed between the upper half-cradle and the lower half-cradle and which is designed to move the lower half-cradle relative to the upper half-cradle between the connected and disconnected positions thereof,
the structuring connection means of the lower half-cradle comprise lateral structuring connecting rods of the trellis of connecting rods, and the structuring connection means of the upper half-cradle are arranged between the front and rear upper half-arms of the upper half-cradle and comprise an upper spar and/or additional connecting rods of the trellis of connecting rods that are separate from the lateral structuring connecting rods of the trellis of connecting rods,
the means for attaching the gas generator comprise two flexible pads for attaching the gas generator that are supported by the front upper half-arms, two flexible pads for attaching the gas generator that are supported by the rear upper half-arms, and two flexible pads for attaching the gas generator that are supported by the front lower half-arms,
the means for attaching the gas generator comprise two flexible attachment pads supported by the front lower half-arms and two attachment yokes supported by the rear lower half-arms.

The invention also relates to a method for maintaining an aircraft turbine engine supported during operation by a cradle, characterised in that it comprises, according to a first variant:
a removal method comprising:
   a first step in which the two flexible pads for attaching the gas generator that are supported by the front lower half-arms are removed,
   a second step in which the locks are unlocked,
   a third step in which said at least one actuator is actuated in order to cause the only lower half-cradle to lower vertically,
a removal method comprising
   a first step in which said at least one actuator is actuated in order to cause the only lower half-cradle to rise vertically,
   a second step in which the locks are locked,
   a third step in which the two flexible pads for attaching the gas generator that are supported by the front lower half-arms are re-installed, and
   a step, subsequent to the second step, in which the visual indicators of the locks are examined.

The invention also relates to a method for maintaining an aircraft turbine engine supported during operation by a cradle, characterised in that it comprises, according to a second variant:
a removal method comprising:
   a first step in which the two flexible pads for attaching the gas generator that are supported by the front upper half-arms and the two flexible pads for attaching the gas generator that are supported by the rear upper half-arms are removed,
   a second step in which the locks are unlocked,
   a third step in which said at least one actuator is actuated in order to cause the lower half-cradle (10B), equipped with the gas generator, to lower vertically,

and/or
a re-installation method comprising:
   a first step in which said at least one actuator is actuated in order to cause the lower half-cradle, equipped with the gas generator, to rise vertically,
   a second step in which the locks are locked,
   a third step in which the two flexible pads for attaching the gas generator that are supported by the front upper half-arms and the two flexible pads for attaching the gas generator that are supported by the rear upper half-arms are re-installed,
   a step, subsequent to the second step, in which the visual indicators of the locks are examined.

The invention finally relates to a method for maintaining an aircraft turbine engine of the turboprop engine type supported during operation by a cradle, characterised in that it comprises, according to a third variant:
a removal method comprising:
   a first step in which the gas generator is decoupled from a reduction gear of the turboprop engine,
   a second step in which the locks are unlocked,
   a third step in which said at least one actuator is actuated in order to cause the lower half-cradle, equipped with the gas generator, to lower vertically,

and/or
a re-installation method comprising:
   a first step in which said at least one actuator is actuated in order to cause the lower half-cradle, equipped with the gas generator, to rise vertically,
   a second step in which the locks are locked,
   a third step in which the gas generator is coupled to the reduction gear,
   a step, subsequent to the second step, in which the visual indicators of the locks are examined.

The invention will be better understood, and other details, features and advantages of the present invention will become clearer upon reading the following description, given by way of non-limiting example with reference to the accompanying drawings, in which

FIG. 1 (already mentioned) is a side view of a turboprop engine received in an aircraft cradle;

FIG. 2 is a schematic perspective view showing the insertion of the components of a turboprop engine into a cradle according to a first variant of the invention and shown in the assembled position;

FIG. 3 is a schematic perspective view showing the insertion of the components of a turboprop engine into a cradle according to the first variant of the invention and shown in the disassembled position;

FIG. 4 is a schematic perspective view showing the insertion of the components of a turboprop engine into a cradle according to the second variant of the invention and shown in the assembled position;

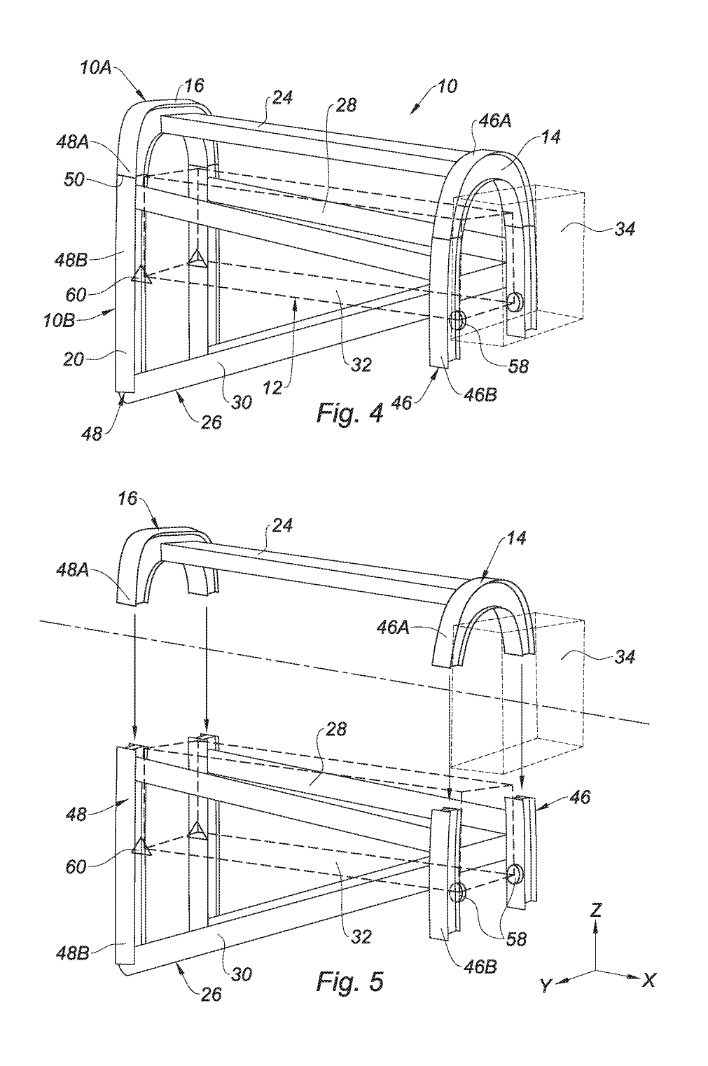

FIG. 5 is a schematic perspective view showing the insertion of the components of a turboprop engine into a cradle according to the second variant of the invention and shown in the disassembled position;

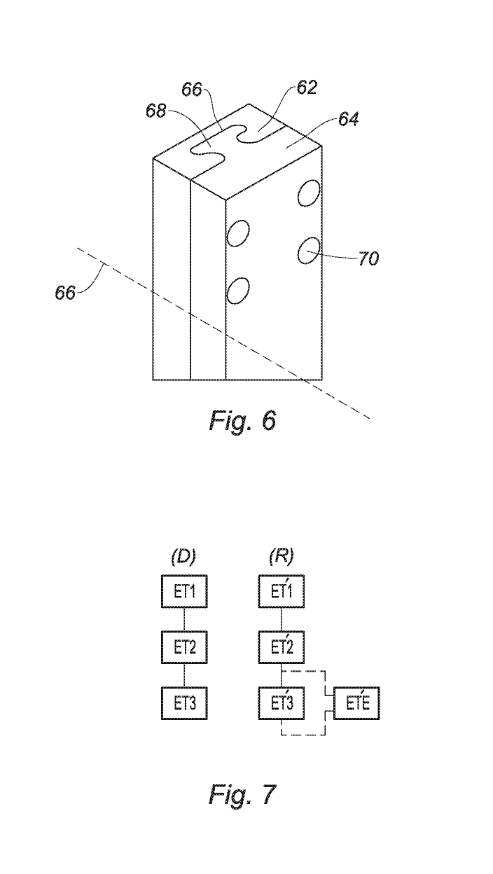

FIG. 6 is a detailed perspective view of the means for guiding the upper and lower half-cradles; and

FIG. 7 is a block diagram of a first and second embodiment of the maintenance method according to the invention.

In the following description, identical reference numerals designate identical parts or parts having similar functions. The cradle 10 will be described by reference to an axis system X, Y, Z, the axis X of which is a horizontal axis that is substantially parallel to an axis A of the gas generator, the axis Y is a transverse, substantially horizontal axis that is orthogonal to the axis X and the axis Z is a transverse, substantially vertical axis that is orthogonal to the axis X.

FIGS. 2 to 5 show a cradle 10 produced in accordance with the invention.

In the same way as the cradle 10 described previously with reference to the prior art, the cradle 10 is suitable for receiving a substantially horizontal turboprop engine 12 comprising, as is known, a gas generator 32 having a substantially horizontal longitudinal axis A and a reduction gear 34.

This configuration is shown in FIGS. 2 to 5 and it will be understood that said configuration does not limit the invention. The cradle 10 could be suitable for receiving a turbine engine of another type, for example a bypass turbine engine.

In the embodiment in FIGS. 2 to 5, the cradle 10 comprises two arches 14, 16, one front and one rear, that are in the shape of an inverted U, extend transversely with respect to the axis A and are open at the lower ends 20, 22 thereof. The arches 14, 16 are interconnected by structuring connection means which comprise an upper axial spar 24 and a trellis 26 of connecting rods which extends between the arches 14, 16 and which comprises, on either side, at least one upper lateral structuring connecting rod 28 and at least one lower lateral structuring connecting rod 30, which are arranged on either side of the arches 14, 16. Alternatively, it is possible for the structuring connection means to not comprise an upper axial spar, which could thus be replaced by supplementary connecting rods (not shown) of the trellis 26 of connecting rods that are separate from the connecting rods 28 and 30.

Moreover, the cradle comprises means 44 for attaching the gas generator 32 to said cradle 10 and means (not shown) for attaching the reduction gear 34 to said cradle 10.

In accordance with the invention, the cradle 10 is produced in at least two portions 10A and 10B. Said cradle more specifically comprises an upper half-cradle 10A which is designed to be attached to a wing of the aircraft and which comprises at least some of the means (not shown) for attaching the reduction gear 34. As is known per se, said attachment means may consist of flexible pads or rigid bolted connections.

The cradle 10 comprises a lower half-cradle 10B which is movable between a position in which it is connected to the upper half-cradle 10A, shown in FIGS. 2 and 4, and a position in which it is disconnected from the upper half-cradle 10A, shown in FIGS. 3 and 5. The lower half-cradle 10B comprises, as will be seen in greater detail in the rest of the present description, at least some of the means 44 for attaching the gas generator 32, and the remaining means for attaching the reduction gear 34. Said attachment means may, for example, consist of flexible pads that can be detached from the reduction gear 34.

In a variant, the upper half-cradle 10A could comprise all the means for attaching the reduction gear 34. In this case, the lower half-cradle 10B would not comprise any means for attaching the reduction gear 34.

The lower half-cradle 10B comprises, on either side thereof, the upper 28 and lower 30 lateral structuring connecting rods of the trellis 26 of connecting rods. In accordance with the invention, the cradle 10 comprises means 50 for slidably guiding, in a vertical direction V which is substantially perpendicular to the substantially horizontal direction X, the lower half-cradle 10B relative to the upper half-cradle 10A, between the connected and disconnected positions thereof. The position of said means is shown by the reference line 50 in FIGS. 2 to 5, and said means are depicted in greater detail in FIG. 6.

In FIGS. 2 to 5, the cradle 10 is adapted to a turbine engine of the turboprop engine type. In the case where the cradle 10 is more specifically adapted to a turbine engine such as a bypass turbine engine, the lower half-cradle 10B could, while comprising the upper 28 and lower 30 lateral structuring connecting rods of the trellis 26 of connecting rods, be shaped as a half-barrel in order to match the shape of the gas generator 32 as best as possible.

Finally, the cradle 10 comprises means for locking the lower half-cradle 10B relative to the upper half-cradle 10A in the connected position thereof from FIGS. 2 and 4.

In the cradle 10 generally comprising arches 14, 16 in the shape of an inverted U, each arch, front 14 and rear 16, comprises substantially vertical arms 46, 48. Each arm 46, 48 comprises an associated upper half-arm 46A, 48A, which is thus part of the upper half-cradle 10A, and an associated lower half-arm 46B, 48B, which is thus part of the lower half-cradle 10B. The means 50 for slidable guiding are interposed between the upper half-arms 46A, 48A and the lower half-arms 46B, 48B corresponding thereto, or are supported by the upper half-arms 46A, 48A and the lower half-arms 46B, 48B corresponding thereto.

According to a first embodiment of the cradle 10 shown in FIGS. 2 and 3, the means 44 for attaching the gas generator 32 comprise two flexible pads 52 for attaching the gas generator that are supported by the front upper half-arms 46A, two flexible pads 54 for attaching the gas generator that are supported by the rear upper half-arms 48A, and two flexible pads 56 for attaching the gas generator that are supported by the front lower half-arms 46B.

This configuration allows, by previously removing the flexible pads 56 for attaching the gas generator 32 that are supported by the front lower half-arms 46B, to disassemble the cradle 10 by separating the lower half-cradle 10B from the upper half-cradle 10A, the suspension of the gas generator 32 in this case being ensured solely by the flexible pads 52, 54 supported by the front upper half-arms 46A and the rear upper half-arms 48A, respectively. This configuration is very advantageous since it makes it possible, by removing the lower half-cradle 10B, to access the gas generator 32, the upper 28 and lower 30 structuring connecting rods of the trellis 26 of connecting rods being removed together with the lower half-cradle 10B and no longer impeding access to the gas generator 32.

It will be understood that, in this configuration, the reduction gear 34 remains sufficiently attached to the upper half-cradle 10A, and in particular to the front arch 14 thereof, which comprises all or some of the means for attaching the reduction gear 34, so as to ensure that said reduction gear is held.

According to a second embodiment of the cradle 10 shown in FIGS. 4 and 5, the means for attaching the gas generator 32 comprise two flexible attachment pads 58 that are supported by the front lower half-arms 46B, and two attachment yokes 60 that are supported by the rear lower half-arms 48B.

This configuration allows, by previously disconnecting the gas generator 32 from the reduction gear 34, to disassemble the cradle 10 by separating the lower half-cradle 10B from the upper half-cradle 10A, the gas generator 32 remaining rigidly connected to the lower half-cradle 10B and being able to be lowered together with said lower half-cradle. The suspension of the gas generator 32 is in this case ensured solely by the flexible pads 58 supported by the front lower half-arms 46B and the yokes 60 supported by the rear lower half-arms 48B. This configuration is very advantageous since it allows, by removing the lower half-cradle 10B together with the gas generator, to access the gas generator 32 via the upper portion thereof, and to then remove said gas generator from the lower half-cradle 10B.

It will be understood that, in this configuration too, the reduction gear 34 remains sufficiently attached to the upper half-cradle 10A, and in particular to the front arch 14 thereof, which comprises all or some of the means for attaching the reduction gear 34, so as to ensure that said reduction gear is held.

Irrespective of the embodiment implemented, the guiding means are identical. Thus, as shown in FIG. 6, each means 50 for slidable guiding comprises a rail 62 that is rigidly connected to an upper or lower half-arm and slidably receives a complementary member 64 that is rigidly connected to the other lower or upper half-arm, respectively. For example, the rail 62 may be rigidly connected to one of the upper half-arms 46A, 48A and may comprise a track 66 in the shape of a dovetail and intended to receive a complementary dovetail tenon 68 that is supported by the member 64. The rail 62 and members 64 may be integrated in the half-arms 46A, 46B, 48A, 48B, or joined thereto. For example, in FIG. 5, the member 64 is connected to the corresponding lower half-arm 46B, 48B by means of screws received in holes 70 in said member.

The means for locking the lower half-cradle 10B relative to the upper half-cradle 10A in the connected position thereof may take any form known from the prior art. However, preferably, said means comprise at least two locks interposed between at least two lower 48B and upper 48A half-arms of the rear arch 16 and at least two lower 46B and upper 48A half-arms of the front arch 14. It is indeed important that at least each arch comprises a lock. Indeed, one lock would suffice for locking the front 10A and rear 10B half-cradles relative to one another, but the functional clearances of the rails 62 and members 64 of an arch not provided with a lock would be able to be cancelled out by the weight of the gas generator 32, which then overhangs the opposite arch, and would risk causing the members 64 to jam in the rails 62. Moreover, the presence of at least two locks reinforces the security of the locking.

Each lock is generally interposed between a lower 48B and upper 48A half-arm of the rear arch 16 or two lower 46B and upper 48A half-arm of the front arch 14. This means that the locks may be arranged directly between said half-arms or between rails 62 and members provided on said half-arms. For illustrative purposes, in FIG. 6, the possible position of a lock, drawn as a dashed line, is shown by reference sign 66. Each lock may take any form known from the prior art, such as a latch lock or lever lock.

In preferred embodiments of the invention, in which each lock is movable between an unlocked position and a locked position, a lock will preferably be chosen which comprises a visual indicator of the locked position thereof, in order to allow visual checking, without tampering, of proper locking of the lower half-cradle 10B onto the upper half-cradle 10A.

Moreover, in order to allow the raising and lowering of the lower half-cradle 10B, the cradle 10 comprises at least one actuator (not shown in the figures) which is interposed between the upper half-cradle 10A and the lower half-cradle 10B. Said actuator is designed to move the lower half-cradle between the connected and disconnected positions thereof. For example, the actuator or the actuators may be interposed between the upper half-arms 46A, 48A and the lower half-arms 46B, 48B corresponding thereto.

The structuring connection means are divided between the two half-cradles 10A and 10B. As noted above, the structuring connection means of the lower half-cradle 10B comprise, on either side thereof, the upper 28 and lower 30 lateral structuring connecting rods of the trellis 26 of connecting rods. Similarly, the structuring connection means of the upper half-cradle 10A, which are arranged between the front 46A and rear 48A upper half-arms of the upper half-cradle 10A, in particular comprise the upper spar 24.

The upper half-cradle 10A may comprise reinforcement means in order to make it possible to maintain sufficient rigidity once the lower half-cradle 10B has been removed.

Said reinforcement means may consist of a reinforcement of the upper spar 24. In a variant, said reinforcement means could consist of additional connecting rods of the trellis 26 of connecting rods that are separate from the lateral structuring connecting rods 28, 30 of the trellis 26 of connecting rods.

The two embodiments of the invention allow to envisage three different variants of methods for maintaining the turboprop engine 12. The block diagram in FIG. 7 applies to these three variants.

According to a first variant, which can be applied to any type of turbine engine, the maintenance method comprises a removal method D comprising a first step ET1 in which the two flexible pads 56 for attaching the gas generator 32 that are supported by the front lower half-arms 46B are removed. Next, the removal method comprises a second step ET2 in which the locks are unlocked, then a third step ET3 in which the at least one actuator is actuated in order to cause the only lower half-cradle 10B to lower vertically.

It is then possible to access the gas generator 32 of the turbine engine without being impeded by the trellis 26 of connecting rods.

According to this first variant, the maintenance method also comprises a re-installation method R comprising a first step ET′1 in which said at least one actuator is actuated in order to cause the only lower half-cradle 10B to rise vertically, then a second step ET′2 in which the locks are locked, then a third step in which the two flexible pads 56 for attaching the gas generator 32 that are supported by the front lower half-arms 46B are re-installed.

During said re-installation method R, a step ET′E, subsequent to the second step ET′2, is necessarily introduced in which the visual indicators of the locks are examined in order to ensure proper locking of the lower half-cradle 10B. Said step ET′E may, for example, be introduced immediately after step ET′2 or after step ET′3, as shown by the dashed lines in FIG. 7.

According to a second variant, which is preferably applicable to a bypass turbine engine of the turbojet engine type, the maintenance method comprises a removal method D comprising a first step ET1 in which the two flexible pads 52 for attaching the gas generator that are supported by the front upper half-arms 46A and the two flexible pads 54 for attaching the gas generator that are supported by the rear upper half-arms 48A are removed, then a second step ET2 in which the locks are unlocked, then a third step in which said at least one actuator is actuated in order to cause the lower half-cradle 10B, equipped with the gas generator 32, to lower vertically.

It is then possible to carry out any maintenance operation on the gas generator 32 outside the aircraft.

According to the second variant, the maintenance method also comprises a re-installation method R comprising a first step ET′1 in which said at least one actuator is actuated in order to cause the lower half-cradle 10B, equipped with the gas generator 32, to rise vertically, then a second step ET′2 in which the locks are locked, then a third step ET′3 in which the two flexible pads 52 for attaching the gas generator that are supported by the front upper half-arms 46A and the two flexible pads 54 for attaching the gas generator that are supported by the rear upper half-arms 48A are re-installed.

During said re-installation method R, a step ET′E, subsequent to the second step ET′2, is necessarily introduced in which the visual indicators of the locks are examined in order to ensure proper locking of the lower half-cradle 10B. Said step ET′E may, for example, be introduced immediately after step ET′2 or after step ET′3, as shown by the dashed lines in FIG. 7.

According to a third variant, which is applicable solely to a turbine engine of the turboprop engine type, the maintenance method comprises a removal method D comprising a first step ET1 in which the gas generator 32 is decoupled from the reduction gear 34, then a second step ET2 in which the locks are unlocked, then a third step in which said at least one actuator is actuated in order to cause the lower half-cradle 10B, equipped with the gas generator 32, to lower vertically.

It is then possible to carry out any maintenance operation on the gas generator 32 outside the aircraft.

According to the third variant, the maintenance method also comprises a re-installation method R comprising a first step ET′1 in which said at least one actuator is actuated in order to cause the lower half-cradle 10B, equipped with the gas generator 32, to rise vertically, then a second step ET′2 in which the locks are locked, then a third step ET′3 in which the gas generator is coupled to the reduction gear.

During said re-installation method R, a step ET′E, subsequent to the second step ET′2, is necessarily introduced in which the visual indicators of the locks are examined in order to ensure proper locking of the lower half-cradle 10B. Said step ET′E may, for example, be introduced immediately after step ET′2 or after step ET′3, as shown by the dashed lines in FIG. 7.

The invention allows to considerably simplify the maintenance operations of a turbine engine supported by a structure forming a cradle, be it a turbine engine of the turbojet engine type or of the turboprop engine type.

1. A cradle for supporting an aircraft turbine engine which is intended to be oriented so as to follow a substantially axial direction and which comprises at least one gas generator, said cradle comprising:
a front arch and a rear arch, which extend transversely with respect to said axial direction, said arches being open at the lower ends thereof and interconnected by structuring connection means comprising at least one trellis of connecting rods that extends between said arches, and said cradle comprising means for attaching the gas generator, said cradle being produced in at least two portions and comprising:
an upper half-cradle designed to be attached to a wing of the aircraft; and
a lower half-cradle being movable between a position in which it is connected to the upper half-cradle and a position in which it is disconnected from the upper half-cradle,
wherein the lower half-cradle comprises at least some of the means for attaching the gas generator, and wherein the cradle comprises:
means for slidably guiding the lower half-cradle in a vertical direction between the connected and disconnected positions thereof; and
means for locking the lower half-cradle relative to the upper half-cradle in the connected position thereof.

2. The cradle according to claim 1, wherein the cradle is designed to support a turbine engine of the turboprop engine type, comprising a reduction gear coupled to the gas generator, and wherein the upper half-cradle comprises at least some of the means for attaching the reduction gear.

3. The cradle according to claim 1 wherein each front and rear arch of the cradle comprises substantially vertical arms, each arm comprising an upper half-arm of the upper half-cradle and a lower half-arm of the lower half-cradle, and wherein the means for slidable guiding are interposed between or supported by the upper half-arms and the lower half-arms corresponding thereto.

4. The cradle according to claim 3, wherein each means for slidable guiding comprises a rail that is rigidly connected to one of an upper or a lower half-arm and slidably receives a complementary member that is rigidly connected to the other one of the lower or the upper half-arm, respectively.

5. The cradle according to claim 4, wherein the means for locking the lower half-cradle relative to the upper half-cradle in the connected position thereof comprise at least two locks interposed between two lower and upper half-arms of the rear arch and two lower and upper half-arms of the front arch.

6. The cradle according to claim 5, wherein each lock is movable between an unlocked position and a locked position, and wherein said lock comprises a visual indicator of the locked position thereof.

7. The cradle according to claim 1, comprising at least one actuator which is interposed between the upper half-cradle and the lower half-cradle and which is designed to move the lower half-cradle relative to the upper half-cradle between the connected and disconnected positions thereof.

8. The cradle according to claim 3, wherein the structuring connection means of the lower half-cradle comprise lateral structuring connecting rods of the trellis of connecting rods, and wherein the structuring connection means of the upper half-cradle are arranged between the front and rear upper half-arms of the upper half-cradle and comprise an upper spar and/or additional connecting rods of the trellis of connecting rods that are separate from the lateral structuring connecting rods of the trellis of connecting rods.

9. The cradle according to claim 3, wherein the means for attaching the gas generator comprise two flexible pads for attaching the gas generator that are supported by the front upper half-arms, two flexible pads for attaching the gas generator that are supported by the rear upper half-arms, and two flexible pads for attaching the gas generator that are supported by the front lower half-arms.

10. The cradle according to claim 3, wherein the means for attaching the gas generator comprise two flexible pads that are supported by the front lower half-arms, and two attachment yokes that are supported by the rear lower half-arms.

11. A method for maintaining an aircraft turbine engine supported during operation by a cradle according to claim 1, the cradle also comprising at least one actuator which is interposed between the upper half-cradle and the lower half-cradle and which is designed to move the lower half-cradle relative to the upper half-cradle between the connected and disconnected positions thereof, wherein the means for locking the lower half-cradle relative to the upper half-cradle in the connected position thereof comprise at least two locks interposed between two lower and upper half-arms of the rear arch and two lower and upper half-arms of the front arch, each lock movable between an unlocked position and a locked position and said lock comprises a visual indicator of the locked position thereof, and wherein the means for attaching the gas generator comprise two flexible pads for attaching the gas generator that are supported by the front upper half-arms, two flexible pads for attaching the gas generator that are supported by the rear upper half-arms, and two flexible pads for attaching the gas generator that are supported by the front lower half-arms, the method comprising:
a removal method comprising:
removing the two flexible pads for attaching the gas generator that are supported by the front lower half-arms;
unlocking the locks; and
actuating said at least one actuator in order to cause the only lower half-cradle to lower vertically,
a re-installation method comprising:
actuating said at least one actuator in order to cause the only lower half-cradle to rise vertically;
locking the locks;
reinstalling the two flexible pads for attaching the gas generator that are supported by the front lower half-arms; and
after locking the locks, examining the visual indicators of the locks.

12. A method for maintaining an aircraft turbine engine supported during operation by a cradle according to claim 1, the cradle also comprising at least one actuator which is interposed between the upper half-cradle and the lower half-cradle and which is designed to move the lower half-cradle relative to the upper half-cradle between the connected and disconnected positions thereof, wherein the cradle is designed to support a turbine engine of the turboprop engine type having a reduction gear coupled to the gas generator and wherein the upper half-cradle comprises at least some of the means for attaching the reduction gear, wherein the means for locking the lower half-cradle relative to the upper half-cradle in the connected position thereof comprise at least two locks interposed between two lower and upper half-arms of the rear arch and two lower and upper half-arms of the front arch, each lock movable between an unlocked position and a locked position and said lock comprises a visual indicator of the locked position thereof, and wherein the means for attaching the gas generator comprise two flexible pads for attaching the gas generator that are supported by the front upper half-arms, two flexible pads for attaching the gas generator that are supported by the rear upper half-arms, and two flexible pads for attaching the gas generator that are supported by the front lower half-arms, the method comprising:
a removal method comprising:
removing the two flexible pads for attaching the gas generator that are supported by the front upper half-arms and the two flexible pads for attaching the gas generator that are supported by the rear upper half-arms;
unlocking the locks; and
actuating said at least one actuator in order to cause the lower half-cradle, equipped with the gas generator, to lower vertically,
and/or
a re-installation method (R) comprising:
actuating said at least one actuator in order to cause the lower half-cradle, equipped with the gas generator, to rise vertically;
locking the locks;
reinstalling the two flexible pads for attaching the gas generator that are supported by the front upper half-arms and the two flexible pads for attaching the gas generator that are supported by the rear upper half-arms; and
after locking the locks, examining the visual indicators of the locks.

13. A method for maintaining an aircraft turbine engine of the turboprop engine type supported during operation by a cradle according to claim 1, the cradle also comprising at least one actuator which is interposed between the upper half-cradle and the lower half-cradle and which is designed to move the lower half-cradle relative to the upper half-cradle between the connected and disconnected positions thereof, wherein the cradle is designed to support a turbine engine of the turboprop engine type having a reduction gear coupled to the gas generator and wherein the upper half-cradle comprises at least some of the means for attaching the reduction gear, wherein the means for locking the lower half-cradle relative to the upper half-cradle in the connected position thereof comprise at least two locks interposed between two lower and upper half-arms of the rear arch and two lower and upper half-arms of the front arch, each lock movable between an unlocked position and a locked position and said lock comprises a visual indicator of the locked position thereof, and wherein the means for attaching the gas generator comprise two flexible pads that are supported by the front lower half-arms, and two attachment yokes that are supported by the rear lower half-arms, the method comprising:
a removal method comprising:
decoupling the gas generator from the reduction gear;
unlocking the locks; and
actuating said at least one actuator in order to cause the lower half-cradle, equipped with the gas generator, to lower vertically,
and/or
a re-installation method comprising:
actuating said at least one actuator in order to cause the lower half-cradle, equipped with the gas generator, to rise vertically;
locking the locks;
coupling the gas generator to the reduction gear; and
after locking the locks, examining the visual indicators of the locks.

14. A cradle for supporting an aircraft turbine engine which is intended to be oriented so as to follow a substantially axial direction and which comprises at least one gas generator, said cradle comprising:
a front arch and a rear arch extending transversely with respect to said axial direction, said front and rear arches being open at the lower ends thereof and interconnected by at least one trellis of connecting rods that extends between said front and rear arches, said cradle comprising an attachment interface for attaching the gas generator,
said cradle being produced in at least two portions and comprising an upper half-cradle configured to be attached to a wing of the aircraft, and a lower half-cradle being movable between a position in which it is connected to the upper half-cradle and a position in which it is disconnected from the upper half-cradle, wherein the lower half-cradle comprises at least a portion of the attachment interface for attaching the gas generator;
a guide configured to slideably guide the lower half-cradle in a vertical direction between the connected and disconnected positions thereof; and
at least one lock configured to lock the lower half-cradle relative to the upper half-cradle in the connected position thereof.
